(19) United States
(12) Patent Application Publication
(10) Pub. No.: US 2008/0139187 A1
(43) Pub. Date: Jun. 12, 2008

(54) SESSION ESTABLISHMENT IN A GROUP COMMUNICATION SYSTEM

(76) Inventor: Ramachandran SUBRAMANIAN, San Diego, CA (US)

Correspondence Address: QUALCOMM INCORPORATED, 5775 MOREHOUSE DR., SAN DIEGO, CA, 92121, US

(21) Appl. No.: 11/609,789

(22) Filed: Dec. 12, 2006

(51) Int. Cl. H04M 3/56

(52) U.S. Cl. 455/416

(57) ABSTRACT

Systems and methods for establishing a limited group communication in a wireless communication system are disclosed. The method and system can include generating a group connection request for k respondents, where k is less than a total number of group members. Invite messages can be transmitted to the group members. Disinvite messages can be transmitted to remaining group members, upon receiving k responses from k respondents of the group.

### BACKGROUND OF THE INVENTION

1. Field

The present invention generally relates to communication systems. More particularly, the invention relates to session establishment in group communication systems.

2. Background

Wireless communication systems have developed through various generations, including a first-generation analog wireless phone service (1G), a second-generation (2G) digital wireless phone service (including interim 2.5 G and 2.75 G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xRTT, “1x”, and 1xEV-DO standards, “1xEV”, for example) or TD-SCDMA.

In wireless communication systems, mobile stations or access terminals receive signals from fixed position base stations that support communication links or services within particular geographic regions adjacent to or surrounding the base stations. One or more of these base stations can be organized into a group referred to as a cell. In order to aid in providing coverage, each cell is often sub-divided into multiple sectors, each corresponding to a smaller service area or geographic region. An array or series of base stations placed adjacent to each other form a communication system capable of servicing a number of system users, over a larger region.

The increased data delivery capability of modern wireless communication systems has provided a platform for enhanced data services in addition to or instead of conventional voice services. Examples of such services include Voice over IP (VoIP), text and video messaging, group communications, streaming video and the like. A group communication system may also be known as a push-to-talk (PTT) system, a net broadcast service (NBS), a dispatch system, or a point-to-multi-point communication system. Typically, a group of access terminal users can communicate with one another using an access terminal assigned to each group member. The term “group member” denotes a group of access terminal users authorized to communicate with each other.

The group may operate over an existing communications system, without requiring substantial changes to the existing infrastructure. Thus, a controller and users may operate in any system capable of transmitting and receiving packet information using Internet Protocol (IP), such as a Code Division Multiple Access (CDMA) system, a Time Division Multiple Access (TDMA) system, a Global System for Mobile Communications (GSM) system, satellite communication systems, combinations of land line and wireless systems, and the like.

In conventional group communication systems, all members of the group are paged and granted access to the group communication after responding to the page. Typically, an originator access terminal initiates a request for a group communication and all members of the group (targets) are paged. As each member of the group responds to the page, they are granted access to the communication so that all members can participate/listen in on the communication.

### SUMMARY OF THE EXEMPLARY EMBODIMENTS

Exemplary embodiments of the present invention are directed to systems and methods for improved session control in group communication systems.

Accordingly, an embodiment of the invention can include a method for group communication in a wireless communication system, the method comprising: generating a group connection request for k respondents, wherein k is less than a total number of group members; transmitting invite messages to the group members; receiving k responses from k respondents of the group members; and transmitting disinvite messages to remaining group members, wherein the remaining group members are group members that are not the k respondents.

Another embodiment of the invention can include an access terminal comprising: logic configured to receive a signal to initiate a limited group communication request; logic configured to determine a number (k) of respondents; and logic configured to transmit a request for a limited group communication with k respondents.

Another embodiment of the invention can include a method for generating a limited group communication request at an access terminal, the method comprising: receiving a signal to initiate a limited group communication request; determining a number (k) of respondents; and transmitting a request for a limited group communication with k respondents.

Another embodiment of the invention can include an apparatus comprising: logic configured to receive a request for a limited group communication with k respondents; logic configured to generate session invite messages for members of the group; logic configured to establish the limited group communication with the k respondents to the session invite messages; and logic configured to generate disinvite messages for remaining group members after k respondents have responded, wherein the remaining group members are members that are not in the k respondents.

Another embodiment of the invention can include a method for processing a limited group communication request, the method comprising: receiving a request for a limited group communication, for k respondents; generating session invite messages for members of the group; establishing the limited group communication with k respondents to the session invite messages and an originator; and generating disinvite messages for remaining group members after k respondents have responded, wherein the remaining group members are members that are not in the k respondents.

Another embodiment of the invention can include a system for group communication in a wireless communication system, the system comprising: means for generating a group connection request for k respondents, wherein k is less than a total number of group members; means for transmitting invite messages to the group members; means for receiving k responses from k respondents of the group members; and means for transmitting disinvite messages to remaining group members, wherein the remaining group members are group members that are not the k respondents.

Another embodiment of the invention can include a computer readable media embodying a method for generating a limited group communication request at an access terminal, the method comprising: receiving a signal to initiate a limited group communication request; determining a number (k) of respondents; and transmitting a request for a limited group communication with k respondents.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 is an illustration of an access terminal in accordance with at least one embodiment of the invention.

FIG. 3 is an illustration of a group communication system in accordance with at least one embodiment of the invention.

FIG. 4 is an illustration of call signal flows in accordance with at least one embodiment of the invention.

FIG. 5 is an illustration of a method for generating a request for a limited group communication in accordance with at least one embodiment of the invention.

FIG. 6 is an illustration of a method for processing a request for a limited group communication in accordance with at least one embodiment of the invention.

FIG. 7 is an illustration of a method for processing a disinvite message for a limited group communication in accordance with at least one embodiment of the invention.

### DETAILED DESCRIPTION OF THE PREFERRED EMBODIMENTS

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile, and may communicate with one or more HDR base stations, referred to herein as modem pool transceivers (MPTs) base station transceivers (BTS), base stations (BS) or more generally as access points. An access terminal transmits and receives data packets through one or more modem pool transceivers to an HDR base station controller, referred to as a modem pool controller (MPC), base station controller (BSC) and/or mobile switching center (MSC). These elements are parts of a network called an access network or radio access network (RAN). An access network transports data packets between multiple access terminals. The access network may be further connected to additional networks outside the access network, such as a corporate intranet or the Internet, and may transport data packets between each access terminal and such outside networks. An access terminal that has established an active traffic channel connection with one or more access points is called an active access terminal, and is said to be in a traffic state. An access terminal that is in the process of establishing an active traffic channel connection with one or more access points is said to be in a connection setup state. An access terminal may be any data device that communicates through a wireless channel and/or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the access point is called a reverse link or traffic channel. The communication link through which an access point sends signals to an access terminal is called a forward link or traffic channel. As used herein the term traffic channel can typically refer to either a forward or reverse traffic channel.

Additionally, although exemplary embodiments of the invention may be described or illustrated in terms of a wireless system and specific technologies such as CDMA 1x and 1xEV systems, those skilled in the art will appreciate that the invention is not limited to the illustrated systems. For example, embodiments of the invention can include any system that can be used to establish a group communication.

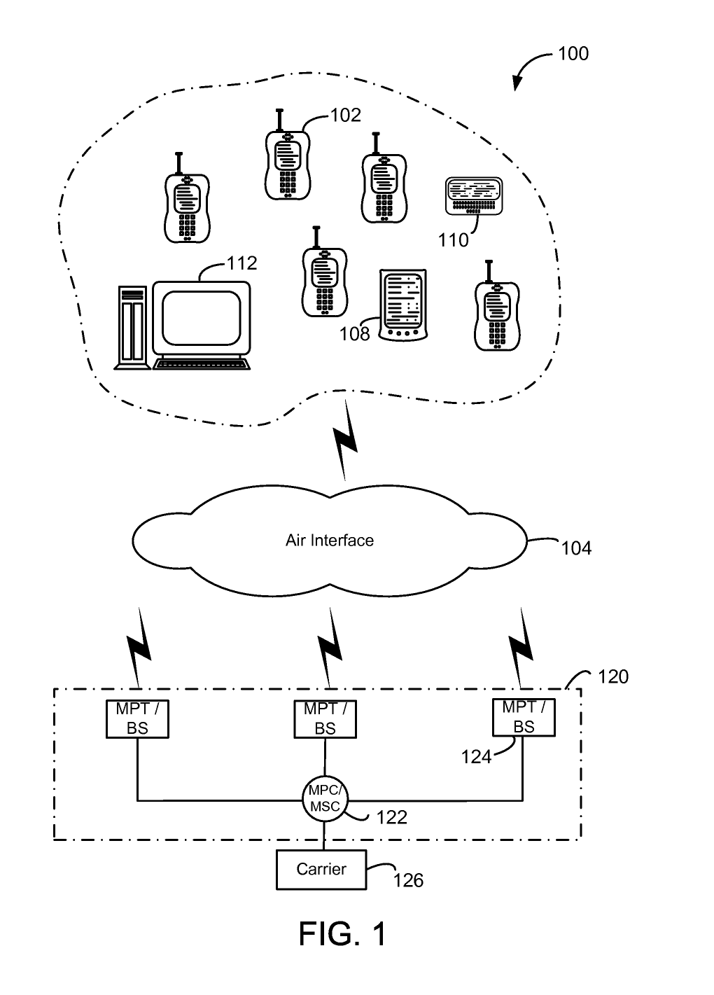

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably. Further as used herein the terms “access point”, “modem pool transceiver (MPT)”, “base transceiver station (BTS)”, “base station (BS)” and like variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, a core network, the Internet, and/or other remote servers.

The RAN 120 controls messages (typically sent as data packets) sent to a MPC/MSC 122. The carrier network 126 may communicate with the MPC/MSC 122 by a network, the Internet and/or a public switched telephone network (PSTN). Alternatively, the MPC/MSC 122 may connect directly to the Internet or external network. Typically, the network or Internet connection between the carrier network 126 and the MPC/MSC 122 transfers data, and the PSTN transfers voice information. The MPC/MSC 122 can be connected to multiple base stations (BS) or modem pool transceivers (MPT) 124. In a similar manner to the carrier network, the MPC/MSC 122 is typically connected to the MPT/BS 124 by a network, the Internet and/or PSTN for data transfer and/or voice communication. The MPT/BS 124 can broadcast data messages wirelessly to the access terminals, such as cellular telephone 102. The MPT/BS 124, MPC/MSC 122 and other components may form the RAN 120, as is known in the art.

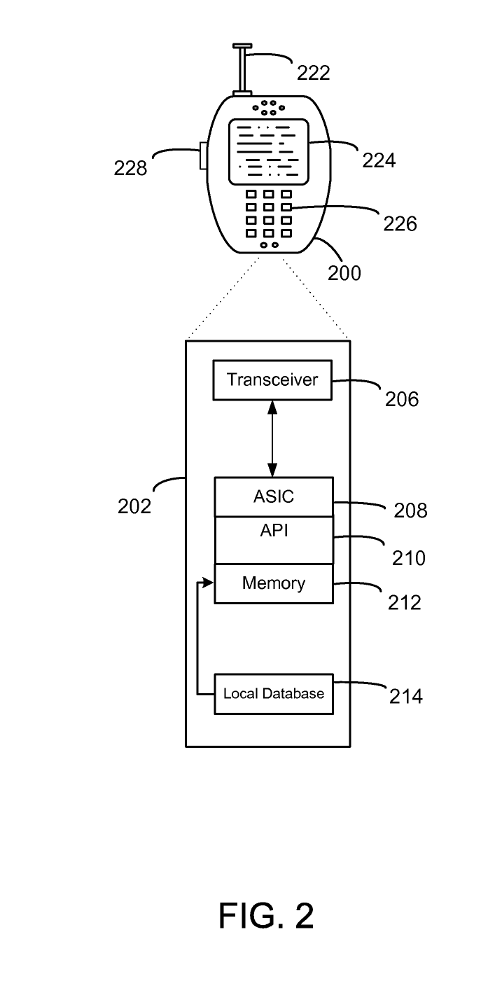

Referring to FIG. 2, the access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor can execute the application programming interface (“API”) 210 layer that may interface with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications/data not actively used in memory 212. The local database 214 is typically a flash memory cell, but can be any secondary storage device as known in the art, such as magnetic media, EEPROM, optical media, soft or hard disk, and the like. The internal platform 202 components can also be operably coupled to external devices such as antenna 222, display 224, push-to-talk button 228 and keypad 226 among other components, as is known in the art.

Accordingly, aspects of the invention may include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 2 are to be considered merely illustrative and the invention is not limited to the illustrated features or arrangement.

As used herein “access terminal” includes, for example, one or more processing circuits executing resident configured logic, where such computing devices include, for example, microprocessors, digital signal processors (DSPs), microcontrollers, or any suitable combination of hardware, software and/or firmware containing processors and logic configured to at least perform the operations described herein. Some examples of access terminals or wireless devices which may be used in accordance with embodiments of the present invention include cellular telephones or other wireless communication units, personal digital assistants (PDAs), paging devices, handheld navigation devices, handheld gaming devices, music or video content download units, and other like wireless communication devices.

The wireless communication between the access terminal 102 and the RAN 120 can be based on different technologies, such as code division multiple access (CDMA), time division multiple access (TDMA), frequency division multiple access (FDMA), the Global System for Mobile Communications (GSM), or other protocols that may be used in a wireless communications network or a data communications network. The data communication is typically between the client device 102, MPT/BS 124, and MPC/MSC 122. The MPC/MSC 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN 120.

As discussed in the background, a group communication system may include a group of access terminal users that communicate with one another using an access terminal assigned to each group member. Although, group communication systems/PTT systems may be considered to be among several members, the system is not limited to this configuration and can apply to communication between individual devices on a one to one basis. Group members may communicate with each other using an assigned access terminal (AT), such as ATs 102, 108, and 112. The ATs may be wireline or wireless devices such as terrestrial wireless telephones, wireline telephones having push-to-talk capability, satellite telephones equipped with push-to-talk functionality, wireless video cameras, still cameras, audio devices such as music recorders or players, laptop or desktop computers, paging devices, or any combination thereof. Furthermore, each AT may be able to send and receive information in either a secure mode, or a non-secure (clear) mode. It should be understood that reference to an access terminal (AT) is not intended to be limited to the illustrated or enumerated examples, and may encompass other devices that have the capability to transmit and receive packet information in accordance with the Internet Protocol (IP).

When a group member wishes to transmit information to other members of the group, the member may request the transmission privilege by pressing a push-to-talk button or key on an AT, which generates a request formatted for transmission over a distributed network. For example, using AT 102, the request may be transmitted over the air to one or more MPTs (or base stations) 124. A MPC/MSC 122, which may include a well-known inter-working function (IWF), packet data serving node (PDSN), or packet control function (PCF), for processing data packets may exist between MPT/BS 124 and the distributed network. However, the requests may also be transmitted through the public switched telephone network (PSTN) to a carrier network 126. The carrier network 126 may receive the request and provide it to the RAN for delivery to an access terminal.

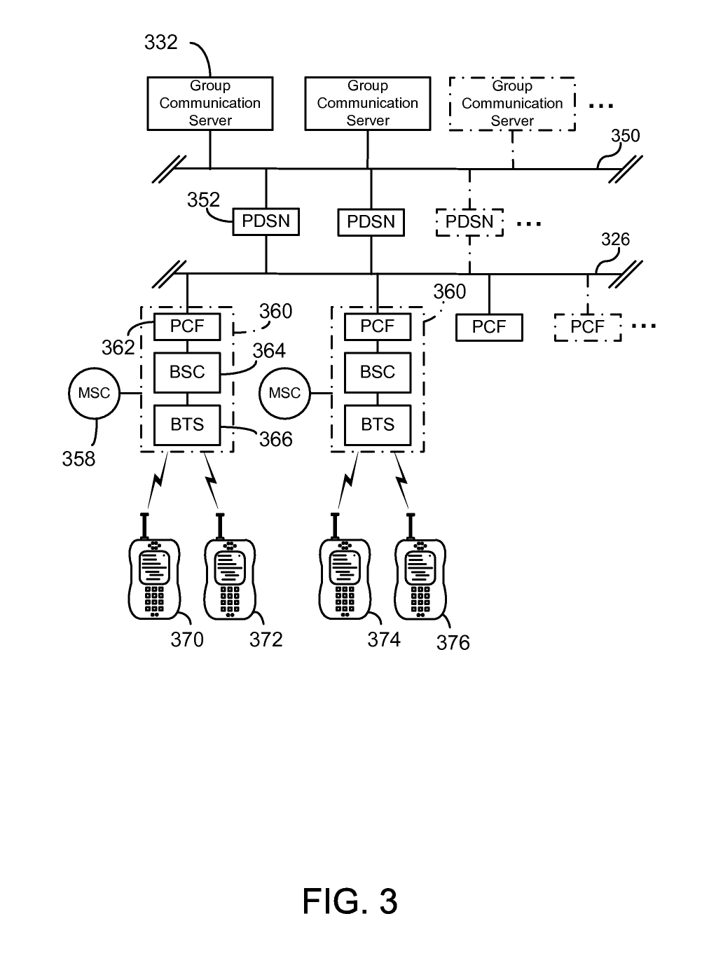

Referring to FIG. 3, one or more group communication servers 332 can monitor traffic of the group communication system through its connection to the distributed network. Since group communication server 332 can be connected to the distributed network through a variety of wired and wireless interfaces, geographic proximity to group participants is not necessary. Typically, a group communication server 332 controls communications between the wireless devices of group members (ATs 370, 372, 374, 376) in a group communication/PTT system. The wireless network illustrated is merely exemplary and can include any system whereby remote modules communicate over-the-air between and among each other and/or between and among components of a wireless network including, without limitation, wireless network carriers and/or servers. Additionally, a series of group communication servers 332 may be connected to a group communication server LAN 350.

The group communication server(s) 332 can be connected to a wireless service provider's packet data service node (PDSN) such as PSDN 352, shown here resident on a carrier network 326. Each PSDN 352 can interface with a base station controller (BSC) 364 of a base station 360 through a packet control function (PCF) 362. The PCF 362 may be located in the base station 360. The carrier network 326 may control messages (generally in the form of data packets) sent to a MSC 358. The MSC 358 can be connected to one or more base stations 360. In a similar manner to the carrier network, the MSC 358 is typically connected to the base station transceiver (BTS) 366 by both the network and/or Internet for data transfer and PSTN for voice information. The BTS 366 ultimately broadcasts and receives messages wirelessly to and from the wireless ATs, such as cellular telephones 370, 372, 374, 376, as is well known in the art. Accordingly, the details of a group communication system will not be further discussed.

As discussed above, with the advent of high data rate wireless systems (e.g., 1x and 1xEV) and the introduction of IP Multimedia Subsystem (IMS) services, it is possible to define groups of people/access terminals for group services. Services such as Push-to-talk Over Cellular (PoC) can use these groups to establish a session between a group of access terminals. The session is typically established as soon as the first access terminal responds to the session invitation. Other invited participants can then join the already established session.

A situation can occur where a subscriber needs to reach any one person in a group of people. The conventional process that the subscriber follows is to try to establish a session with each person/access terminal in the group one by one (e.g., dialing group members one at a time). When an attempt to establish such a session with the chosen person in the group fails, the subscriber then tries the next person in the group.

PoC provides a service that partially addresses this functionality in that using PoC, all the invited users can join the session. Although this avoids the drudgery and delay of dialing each group member individually, the PoC solution unnecessarily allows all group members access even when only one or a designated number will suffice.

Accordingly, embodiments of the invention provide for a group communication (e.g., PoC) server to “disinvite” the other members of the group after one or a designated number of members accepts the session invitation. When the PoC server receives a session origination request, it can determine the identities of the members of the group and send individual invitations (e.g. pages) to each member. The PoC server then waits for responses from the invited members (access terminals). If the origination request indicates not to establish a multiparty session among all the group members, but a one-to-one session with the first member that responds to the invitation. After receipt of the acceptance from any of the invited users, the PoC server can send messages canceling the session invitations (e.g., disinvite messages) to the remaining group members from whom a response has not been received. The session can then be established with the originating access terminal and the responding access terminal (group member) from which a response was received.

In other embodiments of the invention, the system can be generalized so that out of n group members to which a session invitation is sent, the first k (where, k<n) respondents are added to the session. For example, this could be used for establishing group calls, where only a certain number of members may be needed for a specific task. Further, aspects of the invention can be used to conduct an ad hoc lottery, quiz show, or other situations where a limited group of respondents are desired.

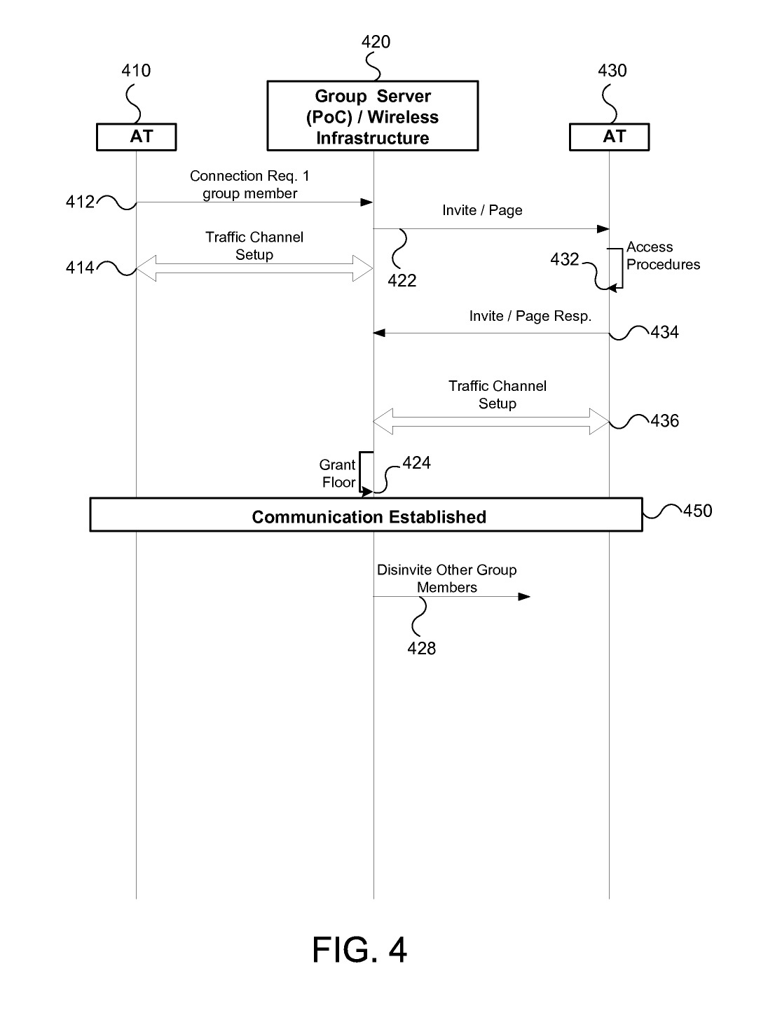

FIG. 4 illustrates a general signal flow chart according to embodiments of the invention. Those skilled in the art will appreciate that the signal flow chart is merely to illustrate aspects of the invention and should not be construed to limit the embodiments of the invention. Further many details of the well known process of establishing group calls and call processing are not detailed so as not to distract from the discussion of aspects of the invention. As illustrated, an originating access terminal (AT) 410 can initiate a connection request 412 for a group call with limited respondents (e.g., one as illustrated). In addition to requesting the connection AT 410 establishes a traffic channel 414 to communicate with the group member(s) as is known in the art. The connection request is received by the group (e.g., PoC) server and wireless infrastructure 420. Then, an invite message/page 422 is sent to all members of the group. For example, AT 430 receives the invite and performs conventional access procedures 432 and then responds to the invite message 434. AT 430 does not need to be informed that a limited group is being requested and does not need to alter its access procedures 432 or response 434. Likewise, AT 430 can establish a traffic channel 436 for communication with AT 410. After the response 434 is received by PoC server 420 the PoC server can grant the floor 424 to one of the ATs 410 or 430 in a typical half duplex communication and communication 450 between the ATs 410 and 430 can begin. However, in embodiments of the invention instead of allowing other group members to join the communication, the PoC server 420 after receipt of the response 434 from the first respondent (or k respondents) can disinvite the remaining group members 428. Accordingly, only one respondent will be connected to the originating AT as specified in the connection request 412.

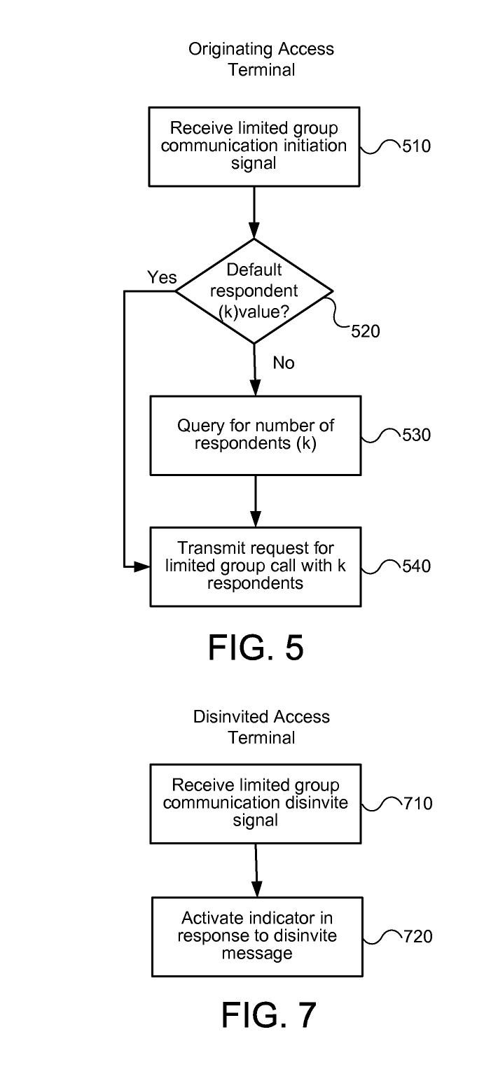

Those skilled in the art will appreciate that embodiments of the invention can include methods for performing the sequence of actions, algorithms and/or functions discussed herein. For example, referring to FIG. 5, an embodiment of the invention can include a method for generating a limited group communication request at an access terminal. The method can include receiving a signal to initiate a limited group communication request, 510. A determination of a number (k) of respondents to the limited group can be made (e.g., 520 or 530). For example, if a default value for k is used, 520, the determination is merely using the default value (e.g., only one respondent from the group). However, if a default value is not used then a user can be queried to enter a value for k, to determine the k respondents, 530. Regardless of how k gets defined, a request can then be transmitted for a limited group call with k respondents, 540. Further, as discussed in the foregoing, k is not limited to one and may be selected from the range of O<k<n, where n is the number of group members. Further, those skilled in the art will appreciate that the signal to initiate the limited group communication request can be generated in any convenient manner. For example, the signal can be generated by activating a push-to-talk button, activating a soft key, selecting a menu item (e.g., using a five-way navigation device) and other know methods for use on access terminals, such as cellular phones. Accordingly, the originating access terminal can initiate the process for establishing a limited group communication.

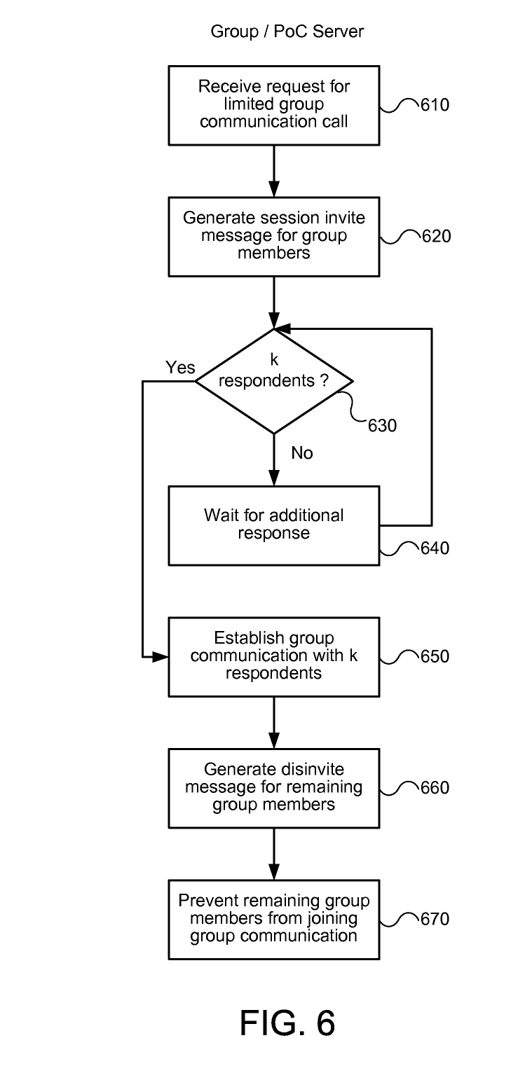

Referring to FIG. 6, another embodiment of the invention can include methods for processing a limited group communication request. The method can include receiving a request for a limited group communication for k respondents, 610. Then, session invite messages can be generated for members of the group, 620. As discussed in the foregoing, typically all members of the group will have a session invite sent to them as in a conventional group (e.g., PoC) communication process. However, the limited group communication is established with only k respondents to the session invite messages, 650, after the k respondents have responded to the invite. However, a group session may be started with less than the k respondents if k is greater than one and the other respondents can be added to the group communication until k is reached.

However, if less than k responses 630, have been received from the group members (i.e., less than k respondents) then the process waits until the k responses are received, 640, prior to generating disinvite messages for the remaining group members, 660. The remaining group members are group members that are not in the k respondents. Further, the remaining group members can be prevented from joining the limited group communication, 670. This can be used to prevent remaining group members that have sent a response prior to receiving the disinvite message from being joined in the limited group.

Referring to FIG. 7, the disinvite message may be processed at the disinvited access terminals according to embodiments of the invention. Since the remaining group members (e.g., access terminals not in the respondent group) may have received an invite message and be in the process of responding or responded when the disinvite message is received, it may be beneficial to provide some notification regarding the disinvite message. For example, a disinvited access terminal can receive the disinvite message, 710. Then, an indicator can be activated at the access terminal to indicate the disinvite message was received. For example, a message can be displayed to inform the user that the maximum number of respondents has joined the group communication and that no additional respondents are needed. Other indications can be used such as an audible signal, a vibration and/or optical signal (e.g., flashing indicator) can be used to let a user know response to the invite message is no longer needed.

Further, other embodiments of the invention can include methods for group communication in a wireless communication system including the functionalities of both the originating access terminal and group server. For example, a method can include generating a group connection request for k respondents, wherein k is less than a total number of group members. Invite messages can be transmitted to the group members. After k responses are received from the group members, disinvite messages can be transmitted to the remaining group members. Further, the remaining group members can be prevented from joining the group communication. Additionally, as discussed above, a user can be prompted for a value of k when generating the group connection request at an originating access terminal or a default value can be used.

In addition to the methods discussed herein, those skilled in the art will appreciate that embodiments of the invention can also include apparatuses that perform the various actions, sequences, algorithms and/or functions described herein. For example, an access terminal can include logic configured to receive a signal to initiate a limited group communication request. The signal can be generated conventionally using a push-to-talk button (e.g., 228), a soft key, a menu item (e.g., on display 224), and/or other known devices to initiate such commands. The access terminal can further include logic configured to determine a number (k) of respondents and logic configured to transmit a request for a limited group communication with k respondents. The value of k can be a default value, so that this value is merely used or can be obtained by logic configured to query a user to enter a value for k, to determine the k respondents. Once again, any known input technique can be used to obtain a value for k, such as keypad 226 or k can be a preprogrammed default value.

Further embodiments of the invention can include an apparatus (e.g., group server, PoC server, wireless system and/or combinations thereof) for processing the limited group communication request. For example, the apparatus (e.g., PoC server) can include logic configured to receive a request for a limited group communication with k respondents and logic configured to generate session invite messages for group members. Further, the apparatus can include logic configured to establish the limited group communication with the k respondents to the session invite messages; and logic configured to generate disinvite messages for remaining group members after k respondents have responded. Additionally, logic configured to prevent the remaining group members from joining the limited group communication can be included in the apparatus.

As discussed herein, the logic elements described herein as “logic configured to” may be any form of hardware and/or software that perform the sequence of actions, algorithms, and/or functions described. Further, those skilled in the art will appreciate that the logic may be distributed over many devices or may be integrated into a single device. Accordingly, the foregoing illustrations and discussion should not be used to limit the embodiments of the invention to the illustrated examples of the various embodiments contained herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a single component. In the alternative, the processor and the storage medium may reside as discrete components.

Accordingly, an embodiment of the invention can include computer readable media embodying a method for establishing a limited group communication in accordance with the methods, algorithms, steps and/or functions disclosed herein. For example, an embodiment of the invention can include a computer-readable medium on which is stored a computer program. The computer program comprising instructions which, upon being executed, causes the computing device to perform a process of: receiving a signal to initiate a limited group communication request; determining a number (k) of respondents; and transmitting a request for a limited group communication with k respondents.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for group communication in a wireless communication system, the method comprising:
generating a group connection request for k respondents, wherein k is less than a total number of group members;
transmitting invite messages to the group members;
receiving k responses from k respondents of the group members; and
transmitting disinvite messages to remaining group members, wherein the remaining group members are group members that are not the k respondents.

2. The method of claim 1, wherein k is selected from the range of O<k<n, where n is the number of group members.

3. The method of claim 1, further comprising:
prompting a user for a value of k when generating the group connection request at an originating access terminal.

4. The method of claim 3, wherein the group connection request is initiated by at least one of activating a push-to-talk button, activating a soft key, and selecting a menu item.

5. The method of claim 1, further comprising:
preventing any of the remaining group members from joining the group communication.

6. The method of claim 1, further comprising:
receiving one of said disinvite messages by one of the remaining group members; and
indicating the disinvite message.

7. The method of claim 6, wherein indicating the disinvite message is at least one of a message on a display screen, an audible signal, a vibration, and an optical signal.

8. The method of claim 1, wherein the group members are access terminals associated in a group with an originating access terminal.

9. The method of claim 1, wherein the group communication is a push-to-talk over cellular (PoC) communication.

10. The method of claim 1, further comprising:
establishing communication between the k respondents and an originating access terminal.

11. An access terminal comprising:
logic configured to receive a signal to initiate a limited group communication request;
logic configured to determine a number (k) of respondents; and
logic configured to transmit a request for a limited group communication with k respondents.

12. The access terminal of claim 11, further comprising:
logic configured to query a user to enter a value for k, to determine the k respondents.

13. The access terminal of claim 11, wherein k is a default value and the logic configured to determine the number k uses the default value.

14. The access terminal of claim 11, wherein k is selected from the range of 0<k<n, where n is the number of group members.

15. The access terminal of claim 11, wherein the signal to initiate the limited group communication request is generated by at least one of a push-to-talk button, a soft key, and a menu item.

16. A method for generating a limited group communication request at an access terminal, the method comprising:
receiving a signal to initiate a limited group communication request;
determining a number (k) of respondents; and
transmitting a request for a limited group communication with k respondents.

17. The method of claim 16 further comprising:
querying a user to enter a value for k, to determine the k respondents, wherein k is selected from the range of 0<k<n, where n is the number of group members.

18. The method of claim 16, wherein k is a default value and the determining the number k comprises using the default value.

19. The method of claim 16, wherein the signal to initiate the limited group communication request is generated by a user activated input device.

20. The method of claim 16, wherein the signal to initiate the limited group communication request is generated by at least one of activating a push-to-talk button, activating a soft key, and selecting a menu item.

21. An apparatus comprising:
logic configured to receive a request for a limited group communication with k respondents;
logic configured to generate session invite messages for members of the group;
logic configured to establish the limited group communication with the k respondents to the session invite messages; and
logic configured to generate disinvite messages for remaining group members after k respondents have responded, wherein the remaining group members are members that are not in the k respondents.

22. The apparatus of claim 21, further comprising:
logic configured to prevent the remaining group members from joining the limited group communication.

23. The apparatus of claim 21, wherein k is selected from the range of O<k<n, where n is the number of group members.

24. The apparatus of claim 21, further comprising:
logic configured to delay the generation of the disinvite messages, if k is greater than one and the number of respondents is less than k.

25. The apparatus of claim 21, wherein the apparatus is at least one of a group communication server and a push-to-talk over cellular (PoC) server.

26. A method for processing a limited group communication request, the method comprising:
receiving a request for a limited group communication, for k respondents;
generating session invite messages for members of the group;
establishing the limited group communication with k respondents to the session invite messages and an originator; and
generating disinvite messages for remaining group members after k respondents have responded, wherein the remaining group members are members that are not in the k respondents.

27. The method of claim 26, further comprising:
preventing the remaining group members from joining the limited group communication.

28. The method of claim 26, wherein k is selected from the range of O<k<n, where n is the number of group members.

29. The method of claim 26, further comprising:
delaying the generation of the disinvite messages, if less than k responses have been received from the group members.

30. The method of claim 26, wherein establishing the limited group communication with k respondents further comprises:
establishing the limited group communication with less than k respondents to the session invite messages and an originator; and
joining additional respondents until k respondents are joined in the limited group communication.

31. A system for group communication in a wireless communication system, the system comprising:
means for generating a group connection request for k respondents, wherein k is less than a total number of group members;
means for transmitting invite messages to the group members;
means for receiving k responses from k respondents of the group members; and
means for transmitting disinvite messages to remaining group members, wherein the remaining group members are group members that are not the k respondents.

32. The system of claim 31, wherein k is selected from the range of O<k<n, where n is the number of group members.

33. The system of claim 31, further comprising:
means for preventing any of the remaining group members from joining the group communication.

34. The system of claim 31, further comprising:
means for receiving one of said disinvite messages by one of the remaining group members; and
means for indicating the disinvite message.

35. The system of claim 31, wherein the group members are access terminals associated in a group with an originating access terminal.

36. The system of claim 31, wherein the group communication is a push-to-talk over cellular (PoC) communication.

37. The system of claim 31, further comprising:
means for establishing communication between the k respondents and an originating access terminal.

38. A computer readable media embodying a method for generating a limited group communication request at an access terminal, the method comprising:
receiving a signal to initiate a limited group communication request;
determining a number (k) of respondents; and
transmitting a request for a limited group communication with k respondents.

39. The computer readable media of claim 38, embodying the method further comprising:
querying a user to enter a value for k, to determine the k respondents, wherein k is selected from the range of 0<k<n, where n is the number of group members.

40. The computer readable media of claim 38, wherein k is a default value and the determining the number k comprises using the default value.
